(19) United States
(12) Patent Application Publication
(10) Pub. No.: US 2024/0043641 A1
(43) Pub. Date: Feb. 8, 2024

(54) SELF-REPAIR COMPOSITE MATERIAL AND SENSING PLATFORM UNIT

(71) Applicant: Technion Research and Development Foundation Ltd., Haifa (IL)

(72) Inventors: Hossam HAICK, Haifa (IL); Muhammad KHATIB, Haifa (IL); Walaa SALIBA, Haifa (IL); Orr ZOHAR, Haifa (IL)

(21) Appl. No.: 18/265,705

(22) PCT Filed: Dec. 15, 2021
(86) PCT No.: PCT/IL2021/051494

§ 371 Date: Jun. 7, 2023

Related U.S. Application Data
(60) Provisional application No. 63/125,979, filed on Dec. 16, 2020.

(51) Int. Cl. C08J 7/044; G01N 27/12; C08K 3/04

(52) U.S. Cl. CPC C08J 7/044; G01N 27/127; C08K 3/042; C08K 2003/0806

(57) ABSTRACT

The present invention provides a composite material and a sensing platform unit comprising a self-healing polymer matrix and at least two conductive nanomaterials embedded therein. The polymer matrix has a multi-layer structure comprising a first layer comprising a network of a first nanomaterial, which resistance changes in response to a mechanical damage inflicted on the polymer matrix; and a second layer comprising a network of a second nanomaterial, configured to generate heat under applied voltage. The network of the first nanomaterial and the network of the second nanomaterial are electrically connected to a mutual control circuit which is configured to apply voltage to the second nanomaterial upon a change in resistance of the first nanomaterial. The sensing platform unit further comprises a third layer comprising a network of a third nanomaterial configured to detect at least one of pressure, strain, temperature, pH, humidity, and volatile organic compounds (VOCs).

### FIELD OF THE INVENTION

The present invention is directed to a self-repair composite material and a sensing platform unit, comprising a self-healing polymer and at least two conductive nanomaterials embedded therein, which are connected to a mutual control circuit.

### BACKGROUND OF THE INVENTION

Soft electronics have been revolutionizing the integration of technology into everyday systems, such as, e.g., healthcare diagnostics and monitoring, robotics, and prosthetics. Special attention in the field of soft electronics has been directed towards biomimicking plants and animals to enable multifunctional sensing of physical stimuli (e.g., temperature and pressure), as well as chemical stimuli (e.g., humidity and (bio)chemical compounds), while maintaining long-term durability. Integration of self-healing features into soft-electronic components enables recovery from structural and functional damage, thereby preventing premature failure and degradation.

US Patent Application Publication No. 2018/0231486 to some of the inventors of the present invention discloses a self-healing platform unit for pressure and analyte sensing, and a method for fabrication thereof, the platform unit comprising a self-healing substrate comprising a dynamically crosslinked polymer comprising polymeric chains and crosslinking bridges; at least one self-healing electrode comprising a non-crosslinked polymer and metal microparticles dispersed therein.

A highly water insensitive self-healing elastomer with high stretchability and mechanical strength that can reach 1100% and ≈6.5 MPa, respectively was reported. (Khatib, M., Zohar, O., Saliba, W., Srebnik, S., Haick, H., Highly Efficient and Water-Insensitive Self-Healing Elastomer for Wet and Underwater Electronics. Adv. Funct. Mater. 2020, 1910196). The elastomer exhibited a high (>80%) self-healing efficiency in high humidity and/or different (under)water conditions without the assistance of external physical and/or chemical triggers. Soft electronic devices made from this elastomer were shown to be highly robust and able to recover their electrical properties after damages in both ambient and aqueous conditions.

Despite recent advances, the implementation of self-healing electronic skin (e-skin) under real-world environmental conditions is still being hindered by several challenges. First, there is a need for new design concepts for self-healing electronic materials or hybridization of self-healing polymers with high-performing inorganic nanomaterials to improve their electronic properties and enable integration within digital circuits or advanced electronics (J. Kang, B.-H. T. Jeffrey, Z. Bao, Nat, Electron. 2019, 2, 144). First, the self-healing electronic material's stiffness and mobility should be balanced, to be both deformation-resistant and relatively fast self-healing (J. C. Lai, J. F. Mei, X. Y. Jia, C. H. Li, X. Z. You, Z. Bao, Adv. Mater. 2016, 28, 8277). Second, there is a requirement for a device that works under a wide spectrum of harsh environmental conditions, e.g., one that operates under various humidity levels in air as well as in underwater conditions (C. Majidi, Nat. Electron. 2019, 2, 58; J. Kang, D. Son, G. J. N. Wang, Y. Liu, J. Lopez, Y. Kim, J. Y. Oh, T. Katsumata, J. Mun, Y. Lee, Adv. Mater. 2018, 30, 1706846; Y. Cao, Y. J. Tan, S. Li, W. W. Lee, H. Guo, Y. Cai, C. Wang, B. C.-K. Tee, Nat. Electron. 2019, 2, 75; Y. Cao, H. Wu, S. I. Allec, B. M. Wong, D. S. Nguyen, C. Wang, Adv. Mater. 2018, 30, 1804602; T. P. Huynh, M. Khatib, H. Haick, Adv. Mater. Technol. 2019, 4, 1900081). Third, the self-healing electronic material should be multifunctional to enable simultaneous sensing and decoupling between multiple physical and chemical stimuli (T. P. Huynh, H. Haick, Adv. Mater. 2016, 28, 138; Q. Hua, J. Sun, H. Liu, R. Bao, R. Yu, J. Zhai, C. Pan, Z. L. Wang, Nat. Commun. 2018, 9, 244; D. H. Ho, Q. Sun, S. Y. Kim, J. T. Han, D. H. Kim, J. H. Cho, Adv. Mater. 2016, 28, 2601; X. Wang, Y. Gu, Z. Xiong, Z. Cui, T. Zhang, Adv. Mater. 2014, 26, 1336).

Additionally, there is a need to develop new types and mechanisms of self-repair for improving the recovery of soft electronics, e.g., on-demand self-healing system that allows selective triggering of the self-healing process in designated locations in integrated electronic systems.

### SUMMARY OF THE INVENTION

The present invention provides a composite material and a sensing platform unit being composed of a self-healing polymer and having a self-repair mechanism, for use, inter alia, in artificial and electronic skin. The self-repair mechanism of the composite material and the sensing platform unit is based on detecting and mapping a structural damage to a self-healing polymer matrix using resistive nanostructured pathways and activating a repairing system, which is configured to apply local heat to the damaged areas. The damage detecting networks (DDNs) and repairing system (also termed herein “heater”) can beneficially be composed of various conductive nanomaterials, such as but not limited to, nanowires, nanotubes, and nanoparticles, which are widely used in printed and soft electronics.

The self-repair mechanism of the composite material of the present invention allows targeted, concentrated and precise heating only of the damaged areas without the need to apply heat to the entire polymer matrix, thereby slowing down its degradation, and without affecting the undamaged components of the artificial or electronic skin and their functioning. Additionally, no external source of energy is required, such that the composite material and the sensing platform unit of the present invention can be fully autonomous. In order to enable the repair process at designated locations, the DDNs and the heaters should be connected to a mutual control circuit, which is configured to activate a specific heater in response to the mechanical damage detected by a specific DDN.

The sensing platform unit of the present invention is based on said composite material and further comprises at least one nanomaterial-based sensing element embedded within the self-healing polymer matrix. Accordingly, when mechanical damage is inflicted on the sensing element, it is detected by the adjacent DDN and repaired by the respective heater.

In one aspect, the present invention provides a composite material comprising a self-healing polymer matrix and at least two conductive nanomaterials embedded therein. The polymer matrix has a multi-layer structure comprising a first layer comprising a network of a first nanomaterial, which resistance changes in response to a mechanical damage inflicted on the polymer matrix; and a second layer comprising a network of a second nanomaterial, configured to generate heat under applied voltage. The network of the first nanomaterial and the network of the second nanomaterial are electrically connected to a mutual control circuit which is configured to apply voltage to the network of the second nanomaterial upon a change in resistance of the network of the first nanomaterial.

According to some embodiments, the first layer is disposed on top of the second layer. According to further embodiments, the network of the first nanomaterial and the network of the second nanomaterial are disposed at the same vertical location of the composite material.

According to some embodiments, the first nanomaterial is selected from the group consisting of a carbonaceous material, a metal, a conductive polymer, and combinations thereof. The carbonaceous material can be selected from the group consisting of carbon black nanoparticles, carbon nanotubes (CNTs), graphene, and combinations thereof. In some exemplary embodiments, the first nanomaterial comprises carbon black nanoparticles.

According to some embodiments, the network of the second nanomaterial is a percolation network. In further embodiments, the second nanomaterial comprises metallic nanowires. The metallic nanowires can be selected from the group consisting of silver nanowires (AgNWs), gold nanowires (AuNWs), copper nanowires (CuNWs), and combinations thereof. In certain embodiments, the second nanomaterial comprises AgNWs.

According to some embodiments, the self-healing polymer comprises polymeric chains selected from the group consisting of polybutadiene-based poly(urea-urethane) (PBPUU), polypropylene glycol-based poly(urea-urethane) (PPGPUU), polyester-based poly(urea-urethane), and polyimide-based poly(urea-urethane), wherein said polymeric chains are dynamically crosslinked via disulfide crosslinking bridges.

According to some embodiments, the first layer, the second layer or both further comprise at least two electrodes electrically connected to the network of the first nanomaterial and/or the network of the second nanomaterial, respectively, and to the mutual control circuit. According to further embodiments, the network of the first nanomaterial is arranged as a continuous pathway between the at least two electrodes. According to still further embodiments, the continuous pathway is a single continuous electrical pathway. In yet further embodiments, the first nanomaterial covers at least about 5% of a total area occupied by the network. According to additional embodiments, the network of the second nanomaterial has a random network configuration of the second nanomaterial disposed between the at least two electrodes, wherein said network covers at least about 20% of the surface confined by the at least two electrodes.

According to some embodiments, the first layer comprises a plurality of networks of the first nanomaterial and the second layer comprises a plurality of networks of the second nanomaterial, wherein each network of the plurality of networks of the first nanomaterial is associated with a respective network of the plurality of networks of the second nanomaterial, such that the mutual control circuit is configured to apply voltage to any network of the plurality of networks of the second nanomaterial upon a change in the resistance of the respective network of the plurality of networks of the first nanomaterial. According to further embodiments, positions of the plurality of networks of the first nanomaterial along the first layer are aligned with the positions of the plurality of networks of the second nanomaterial along the second layer.

In another aspect, there is provided a sensing platform unit comprising a self-healing polymer matrix and at least three conductive nanomaterials embedded therein. The polymer matrix has a multi-layer structure comprising a first layer comprising a network of a first nanomaterial, which resistance changes in response to a mechanical damage inflicted on the polymer matrix; a second layer comprising a network of a second nanomaterial, configured to generate heat under applied voltage; and a third layer comprising a network of a third nanomaterial configured to detect at least one of pressure, strain, temperature, pH, humidity, and volatile organic compounds (VOCs). The network of the first nanomaterial and the network of the second nanomaterial are electrically connected to a mutual control circuit which is configured to apply voltage to the network of the second nanomaterial upon a change in resistance of the network of the first nanomaterial.

According to some embodiments, the first layer is disposed between the second layer and the third layer. According to further embodiments, the network of the first nanomaterial and the network of the second nanomaterial are disposed at the same vertical location of the composite material.

According to some embodiments, the first nanomaterial is selected from the group consisting of a carbonaceous material, a metal, a conductive polymer, and combinations thereof. The carbonaceous material can be selected from the group consisting of carbon black nanoparticles, carbon nanotubes (CNTs), graphene, and combinations thereof. In some exemplary embodiments, the first nanomaterial comprises carbon black nanoparticles.

According to some embodiments, the network of the second nanomaterial is a percolation network. In further embodiments, the second nanomaterial comprises metallic nanowires. The metallic nanowires can be selected from the group consisting of silver nanowires (AgNWs), gold nanowires (AuNWs), copper nanowires (CuNWs), and combinations thereof. In some exemplary embodiments, the second nanomaterial comprises AgNWs.

According to some embodiments, the third nanomaterial is selected from the group consisting of silver nanowires (AgNWs), metallic nanoparticles capped with an organic coating, single walled carbon nanotubes (SWCNTs), carbon particles, graphene, and combinations thereof.

According to some embodiments, the self-healing polymer comprises polymeric chains selected from the group consisting of polybutadiene-based poly(urea-urethane) (PBPUU), polypropylene glycol-based poly(urea-urethane) (PPGPUU), polyester-based poly(urea-urethane), and polyimide-based poly(urea-urethane), wherein said polymeric chains are dynamically crosslinked via disulfide crosslinking bridges.

According to some embodiments, the first layer, the second layer or both further comprise at least two electrodes electrically connected to the network of the first nanomaterial and/or the network of the second nanomaterial, respectively, and to the mutual control circuit.

According to further embodiments, the network of the first nanomaterial is arranged as a continuous pathway between the at least two electrodes. According to still further embodiments, the continuous pathway is a single continuous electrical pathway. In yet further embodiments, the first nanomaterial covers at least about 5% of a total area occupied by the network. In additional embodiments, the network of the second nanomaterial has a random network configuration of the second nanomaterial disposed between the at least two electrodes, wherein said network covers at least about 20% of the surface confined by the at least two electrodes.

According to some embodiments, the third layer further comprises at least two electrodes electrically connected to the network of the third nanomaterial.

According to some embodiments, the first layer comprises a plurality of networks of the first nanomaterial, the second layer comprises a plurality of networks of the second nanomaterial, and the third layer comprises a plurality of networks of the third nanomaterial, wherein each network of the plurality of networks of the first nanomaterial is associated with a respective network of the plurality of networks of the second nanomaterial, such that the mutual control circuit is configured to apply voltage to any network of the plurality of networks of the second nanomaterial upon a change in the resistance of the respective network of the plurality of networks of the first nanomaterial. According to further embodiments, positions of the plurality of networks of the first nanomaterial along the first layer is aligned with the positions of the plurality of networks of the second nanomaterial along the second layer.

According to some embodiments, the third layer comprising at least one of a temperature sensor comprising AgNWs, pressure sensor comprising AgNWs and carbon black-PPGPUU composite, and a pH sensor comprising AgNWs and semi-conductive SWCNTs.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1A: Schematic representation of the self-repair sensing platform unit, in accordance with some embodiments.

FIG. 1B: Schematic representation of the top sensing layer of the self-repair sensing platform unit, in accordance with some embodiments.

FIG. 1C: Schematic representation of the middle damage detection layer of the self-repair sensing platform unit, in accordance with some embodiments.

FIG. 1D: Schematic representation of the bottom self-repair (heater) layer of the self-repair sensing platform unit, in accordance with some embodiments.

FIG. 1E: Flowchart schematically showing the damage detection and self-repair process performed by the self-repair sensing platform unit, in accordance with some embodiments.

FIG. 1F: Electric circuit diagram of the self-repair sensing platform unit.

FIG. 2A: Chemical structure of a polybutadiene-based poly(urea-urethane) (PBPUU) polymer.

FIG. 2B: Photograph of the PBPUU film.

FIG. 2C: Scanning Electron Microscopy (SEM) image of silver nanowires (AgNWs) embedded into the surface of PBPUU (scale bar: 2 μm).

FIG. 3A: Optical images showing the self-healing process for a surface scratch at 25° C. (scale bar: 200 μm).

FIG. 3B: Self-healing of a AgNW-based electrode under varying manual blade-cuts assessed by the change in its resistance.

FIG. 3C: Normalized resistance of the AgNW-based electrode after repetitive cycles of scotch tape attachment and removal.

FIG. 4A: Photograph of the self-healing DDN array.

FIG. 4B: Photograph of the self-healing AgNWs-based heater.

FIG. 4C: Schematic cross-sectional representation of the heater structure.

FIG. 4D: Photograph of the double layer of the heater and DDNs used for damage detection and repair.

FIG. 5A: Thermal map obtained under different voltages applied to the AgNWs-based heater. The temperature range in ° C. is given above each image.

FIG. 5B: Temperature of the heater versus time under varying voltages.

FIG. 5C-5D: AgNWs-based heater performance before and after self-healing (squares—pristine, circles—first healing, triangles—second healing); FIG. 5C: Maximum spatial temperature (Tₘₐₓ) as a function of voltage, FIG. 5D: heater current as a function of voltages.

FIG. 5E: Heat localization on damaged areas—top: schematic representation of the damages inflicted on the film (i, pristine film), and the corresponding temperature distribution (bottom). Starting from a non-homogeneous heater where the density of nanowires is higher on the left side leading to heat localization on the right side of the heater. Making damages on the left side leads to the appearance of other heat localizing areas close to the damaged area (ii-iv).

FIGS. 5F-5G: Images of the self-healing process with heating at 70° C. (Scale bar: 200 μm), FIG. 5F—image taken at <60 sec after the damage was inflicted and FIG. 5G—image taken at <60 sec after the damage was inflicted, and exactly 30 sec after the heating has started.

FIG. 5H: Images of the self-healing process of huge cuts (˜100 μm in width) under 70° C. (top) and room temperature (bottom). The circle and arrow show a small recovered part of the total cut.

FIG. 5I: Photograph of the self-healing heater array used for the autonomic self-repair.

FIG. 5J: Snapshots showing the operation of the autonomic self-repair system; local heat is applied to the damaged area until it recovers; each shot shows the activation/deactivation of different heaters according to the location of the damaged area.

FIG. 6A: Photograph of the sensing (third) layer of the polymer matrix comprising 3 different sensors: temperature, pressure and pH (scale bar: 1 cm).

FIG. 6B: Schematic representation of the structure and configuration of the different sensors of the third layer of the polymer matrix.

FIGS. 6C-6D: Temperature sensing—changes in normalized resistance with temperature (FIG. 6C) and normalized responses to temperature before and after self-healing (FIG. 6D).

FIGS. 6E-6F: Pressure sensing—changes in normalized resistance with pressure (FIG. 6E) and normalized responses to pressure before and after self-healing (FIG. 6F).

FIGS. 6G-6H: pH sensing—transistor transfer curves showing the responses to different pH values between 4 and 9; V_{ds}=−0.8 V (FIG. 6G) and normalized Ion current values obtained under varying pH values before and after self-healing (normalized with the current values obtained at pH=3) (FIG. 6H).

FIGS. 7A-7I: Sensing ability and orthogonality between sensors, FIG. 7A response of the pH sensor to the change in pH; FIG. 7B—response of the temperature sensor to the change in pH; FIG. 7C—response of the pressure sensor to the change in pH; FIG. 7D—response of the pH sensor to the change in temperature; FIG. 7E—response of the temperature sensor to the change in temperature; FIG. 7F—response of the pressure sensor to the change in temperature;

FIG. 7G—response of the pH sensor to the change in pressure; FIG. 7H—response of the temperature sensor to the change in pressure; FIG. 7I—response of the pressure sensor to the change in pressure.

FIG. 8A: Photograph of the self-repair sensing platform unit.

FIG. 8B: Demonstration of the operation of the self-repair sensing platform unit including normal sensing, damage on the pressure sensor, damage detection by the DDN, heating and self-healing, and heat (from the activation of the heater) sensing by undamaged temperature sensors. The dashed line marks the time of the damage.

### DETAILED DESCRIPTION OF THE INVENTION

Through the use of nanostructured conductive fillers and a polymer with high self-healing efficiency, the present invention introduces an advanced composite material, which can be employed in artificial and electronic skin, and which is empowered with damage detection, and self-repair mechanism in designated areas. Further provided is a self-repair sensing platform unit, based on said composite material and further comprising multifunctional sensing elements. Hybridization of a self-healing polymer with high-performing inorganic nanomaterials (e.g., AgNWs, carbon black particles, and SWCNT) allows to combine both desirable electronic and mechanical properties for electronic skin applications. However, self-healing polymers tend to suffer from low stiffness, which hinders their integration into digital circuits or advanced electronics. A very efficient pathway that achieves the balances between polymer's stiffness and self-healing ability has been found by the inventors of the present invention. Integration of heaters into stiff materials enables their softening in a controlled manner. This can also be used to turn non-autonomic stiff self-healing materials into autonomic ones without requiring external interventions and continuous monitoring of electronic systems. The skin-inspired on-demand self-repair composite material according to the principles of the present invention allows selective triggering of the self-healing process in designated locations in integrated electronic systems. This self-repair mechanism allows very efficient and fast healing of small- and big-scale damages. Multifunctional self-repair sensing platform units can be obtained by selecting the desired sensing nanomaterials, including temperature, pressure and pH sensing.

According to some aspects and embodiments, the present invention provides a composite material and a sensing platform unit comprising a self-healing polymer matrix, at least two conductive nanomaterials embedded therein, and a control circuit. The polymer matrix has a multi-layer structure comprising a first layer comprising a network of a first nanomaterial, which resistance changes in response to a mechanical damage inflicted on the polymer matrix; and a second layer comprising a network of a second nanomaterial, configured to generate heat under applied voltage. The network of the first nanomaterial and the network of the second nanomaterial are operatively connected to said control circuit (also termed herein “mutual control circuit”), which is configured to apply voltage to the second nanomaterial upon a change in resistance of the first nanomaterial. The composite material according to the principles of the present invention is a self-repair composite material.

According to further aspects and embodiments, the sensing platform unit is based on said composite material, wherein the polymer matrix comprises a third layer comprising a network of a third nanomaterial embedded therein, configured to detect at least one of pressure, strain, temperature, pH, humidity, and volatile organic compounds (VOCs). The sensing platform unit according to the principles of the present invention is a self-repair sensing platform unit.

The term “polymer” and “polymeric material”, as used herein, refer to a macromolecule composed of many repeated subunits, known as monomers. Polymers, both natural and synthetic, are created via polymerization of many monomers. The polymer is composed of polymer chains, said chains being linear or branched.

In some currently preferred embodiments, the polymer is a thermoplastic polymer. The term “thermoplastic polymer”, as used herein, refers to a polymeric material that has thermoplastic processability and recyclability.

In some embodiments, the polymer is an elastomer. The term “elastomer”, as used herein, refers to a polymeric material which exhibits a combination of high elongation or extensibility, high retractability to its original shape or dimensions after removal of the stress or load, with little or no plastic deformation and possesses low modulus and requires a low load to stretch the material.

In some embodiments, the elastomer is a thermoplastic elastomer. The term “thermoplastic elastomer”, as used herein, refers to a polymeric material that has elastomer-like properties and has thermoplastic processability and recyclability.

In some embodiments, the elastomer is a thermoset elastomer. The term “thermoset elastomer” as used herein, refers to polymeric material that has elastomer-like properties and a network structure that is generated or “set” by thermally induced chemical cross-linking reactions.

The term “self-healing”, as used herein, refers in some embodiments to the ability of the polymer to physically recombine following mechanical damage. The self-healing process can be spontaneous or assisted by application of energy, e.g., in a form of heat. In some currently preferred embodiments, the self-healing of the polymer is heat-assisted.

The term “mechanical damage”, as used herein, refers to a partial or full disassociation between two parts of the polymer. Mechanical damage inflicted on the polymer may include, inter alia, a scratch, a partial cut or a full cut. The ten “scratch”, as used herein refers to a disassociation depth of up to about 10% of the polymer thickness. The term “partial cut”, as used herein refers to a disassociation depth of above about 10% but less than 100% of the polymer thickness. The term “full cut”, as used herein refers to a disassociation depth of 100% of the polymer thickness. Mechanical damage can include multiple cycles of mechanical damage.

The term “conductive”, as used herein, refers to electrically conductive or semi-conductive, unless specified otherwise. The terms “electrically conductive” and “semi-conducting”, which are used herein interchangeably, refers to a capability of a material to allow the flow of electrons. The term “semi-conductive”, is used as known in the art and refers to electrical conductivity of a material being intermediate between a metal and an insulator and depending on applied potential, as well as ambient conditions. Typically, a semiconductive material is a material that has a conductivity of from 10³ to 10⁻⁸ Scm⁻¹.

The terms “nanomaterial” and “nanostructure”, which are used herein interchangeably, refer to materials in any dimensional form (zero, one, two, three) and domain size less than 1000 nanometers. The term “domain size,” as used herein, refers to the minimum dimension of a particular material morphology. In the case of powders, the domain size is the grain size. In the case of whiskers and fibers, the domain size is the diameter. In the case of platelets and films, the domain size is the thickness. The nanomaterial can have any shape, such as but not limited to, wires, fibers, tubes, platelets, films, spheres, cones, ovals, cylindrical, cubes, monoclinic, parallelepipeds, dumbbells, hexagonal, truncated dodecahedron, and irregular shaped structures. Non-limiting examples of suitable types of nanomaterials for use as the first, second, and/or third nanomaterials in the composite material and sensing platform unit of the present invention include nanoparticles, nanowires, nanotubes, and nano whiskers.

The term “embedded”, as used herein, is meant to encompass nanomaterials, which are embedded into the bulk of the polymer matrix layers or be present, on the surface of said layers.

The term “operatively connected”, as used herein, refers to a connection between two elements using any suitable technique or techniques, including, inter alia, electrical, optical, and wireless connection, such that information can be shared between said elements. In some embodiments, the term “operatively connected” means electrically connected.

The term “resistance changes in response to a mechanical damage” refers to a change in resistance from a measured baseline resistance of at least about 20%. In some embodiments term “resistance changes in response to a mechanical damage” refers to a change in resistance from a measured baseline resistance of at least about 30%, at least about 50%, at least about 75%, at least about 100%, at least about 3-fold, at least about 5-fold, at least about 10-fold, or at least about 100-fold. Each possibility represents a separate embodiment of the invention.

The term “network”, as used herein, refers to an arrangement of a plurality of nanostructures such that there are multiple overlapping junctions between different nanostructures. The nanostructures within the network can be randomly or semi-randomly arranged or can be arranged in a predetermined pattern.

In some embodiments, the network is a percolation network. The term “percolation network”, as used herein, refers to a network structure wherein unit particles are randomly arranged but are interconnected. When referring to a network of an electrically conducting nanomaterial the term “percolation network” encompasses a network, which electrical properties such as conductance and impedance will change rapidly as the number of connections between the unit particles increases or decreases.

In some embodiments, the plurality of nanostructures in the network provide multiple electrical pathways from one edge of the network to the other such that breaking a relatively small number of junctions will still leave alternative electrical paths from one edge of the network to the other. In certain such embodiments, the network can be thought of as being similar to a fabric, although not woven or tied together in a systematic manner.

In some embodiments, the plurality of nanostructures in the network are arranged to provide a controlled and/or limited number of electrical pathways from one edge of the network to the other such that breaking a relatively small number of junctions will result in a significant decrease of electrical paths from one edge of the network to the other. In certain such embodiments, the network can be thought of as being similar to a neuron-like network.

In some embodiments, the plurality of nanostructures in the network are arranged to provide a single continuous electrical pathway from one edge of the network to the other, such that breaking a relatively small number of junctions will break the electrical path from one edge of the network to the other. In certain such embodiments, the network can be thought of as being similar to a ribbon folded in a manner that while occupying the maximal possible area, has no contacts between its different parts.

According to some embodiments, the network of the first nanomaterial comprises nanostructures arranged in a predefined pattern. In further embodiments, the nanostructures in the network of the first nanomaterial are arranged to provide a single electrical pathway from one edge of the network to the other, while still occupying the highest possible area, such that breaking a relatively small number of junctions will break the electrical path from one edge of the network to the other. Without wishing to being bound by theory or mechanism of action, such single pathway arrangement results in a significant increase in the resistance of the network of the first nanomaterial upon inflicted damage and allows detecting even small-scale damage of the composite material or the sensing platform unit. The relatively high area coverage by the nanostructures (even though arranged in a single pathway), further assists in the detection of small-scale damage.

According to some embodiments, the network of the second nanomaterial comprises nanostructures which are randomly or semi-randomly arranged. In further embodiments, the nanostructures in the network of the second nanomaterial are arranged to provide multiple electrical pathways from one edge of the network to the other such that breaking a relatively small number of junctions will still leave alternative electrical paths from one edge of the network to the other. Without wishing to being bound by theory or mechanism of action, such arrangement provides significant heating when voltage is applied to the second nanomaterial even if parts of the network are damaged. In some embodiments, the network of the second nanomaterial is a percolation network.

The nanostructures within the network can be densely packed to cover up to 100% of the total area occupied by the network or can be loosely packed to provide multiple voids between the nanostructures. The term “total area”, as used herein, refers to the geometrical area formed by the outer boundaries of the network embedded within the polymer, which includes all the nanostructures present within this area.

According to some embodiments, the first nanomaterial is different from the second nanomaterial.

The first nanomaterial can be composed of a carbonaceous material, a metal or metal alloy, or a conductive polymer. Each possibility represents a separate embodiment of the invention. The first material can have any shape, as known in the art, e.g., nanoparticles, nanotubes, nano whiskers, nanostrips, nanorods, nanowires, beads, sheets, fibers, and powders.

According to some embodiments, the first nanomaterial comprises a carbonaceous material. Without wishing to being bound by theory or mechanism of action, the first nanomaterial should have high self-healing ability to allow multiple damage-detecting and damage-healing cycles. It has been found by the inventors of the present invention that carbon-based materials have the required high self-healing capabilities. Non-limiting examples of suitable carbonaceous materials include carbon black, graphitic carbon, graphene sheets or aggregates of graphene sheets, activated carbon, carbon beads, carbon fibers, carbon microfibers, fullerenic carbons, carbon nanotubes (CNTs), multi-walled carbon nanotubes (MWCNTss), single-walled carbon nanotubes (SWCNTs), and materials comprising fullerenic fragments and any combination thereof.

According to some embodiments, the carbonaceous material is selected from the group consisting of carbon black nanoparticles, carbon nanotubes (CNTs), graphene, and combinations thereof.

In some exemplary embodiments, the first nanomaterial comprises carbon black nanoparticles. According to some embodiments, the carbon black nanoparticles have a mean particle size ranging between about 2 and 500 nm. According to further embodiments, the carbon black nanoparticles have a mean particle size ranging between about 10 and 300 nm. According to still further embodiments, the carbon black nanoparticles have a mean particle size ranging between about 20 and 100 nm.

According to some embodiments, the first nanomaterial comprises a metal or metal alloy. Non-limiting examples of suitable metals and metal alloys include Au, Ag, Ni, Co, Pt, Pd, Cu, Al, Au/Ag, Au/Cu, Au/A_{g}/Cu, Au/Pt, Au/Pd, Au/Ag/Cu/Pd. Pt/Rh, Ni/Co, Pt/Ni/Fe and combinations thereof. The metal or metal alloy-based nanomaterial can be in a form of nanoparticles or nanowires.

The term “conductive polymer”, as used in some embodiments, refers to a polymer which is intrinsically electrically-conductive, and which does not require incorporation of electrically-conductive additives (e.g., carbon black, carbon nanotubes, metal flake, etc.) to support substantial conductivity of electronic charge carrier. In further embodiments, the term “conductive polymer” refers to a polymer which becomes electrically-conductive following doping with a dopant. In certain embodiments, said doping comprises protonation (also termed herein “protonic doping”). In still further embodiments, the term “conductive polymer” refers to a polymer which is electrically-conductive in the protonated state thereof, whether said protonation is either partial or full. Alternatively, conducting polymers can be doped via a redox reaction. In yet further embodiments, the term “conductive polymer” refers to a polymer which is electrically-conductive in the oxidized and/or reduced state thereof. The term “conductive polymer”, as used herein, refers in some embodiments to a semiconducting polymer. The term “semiconductive polymer”, as used in some embodiments, refers to a polymer which is intrinsically semi-conductive, and which does not require doping with charge transporting or withdrawing molecules or components to support substantial conductivity of electronic charge carrier.

Nonlimiting examples of suitable conducive polymers include PEDOT-PSS, polyaniline, polythiophenes, and polypyrrole. The conductive polymer-based nanomaterial can be in a form of nanoparticle or nanowires.

According to the principles of the present invention, the network of the second nanomaterial is configured to generate heat under applied voltage. The term “configured to generate heat under applied voltage.”, as used herein, refers to the generation of heat under Joule effect, i.e., the generation of heat when an electric current passes through a conductive material. The first nanomaterial should therefore be both electrically and thermally conductive. In some embodiments, the term “configured to generate heat under applied voltage”, refers to an increase in temperature which is roughly proportional to the square of applied voltage. In some embodiments, the term “configured to generate heat under applied voltage”, refers to a network of the second nanomaterial having a baseline resistance ranging between about 0.1 Ohm to about 100 Ohm.

According to some embodiments, the heating is afforded by the random or semi-random configuration of the network of the second nanomaterial, which is preferably, a percolation network, such as for example, a percolation network of metallic nanowires. In certain such embodiments, the second nanomaterial should have high electric conductivity in order to obtain high current under low voltages applied to the second nanomaterial to achieve efficient heating of the damaged polymer. The term “low voltage”, as used herein, refers in some embodiments, to a voltage of less than about 1V. The resistance of the second nanomaterial can range from about 0.1 Ohm to about 100 Ohm.

According to some embodiments, the second nanomaterial comprises metallic nanowires. Preferably, the metal of the nanowires is a transition metal, more preferably, a noble metal. According to further embodiments, the metallic nanowires are selected from the group consisting of silver nanowires (AgNWs), gold nanowires (AuNWs), copper nanowires (CuNWs), and combinations thereof. In some exemplary embodiments, the second nanomaterial comprises AgNWs. Additional information on the Joule heating provided by AgNWs can be found in S. Hong, H. Lee, J. Lee, J. Kwon, S. Han, Y. D. Suh, H. Cho, J. Shin, J. Yeo, S. H. Ko, Adv. Mater, 2015, 27, 4744; and S. Choi, J. Park, W. Hyun, J. Kim, J. Kim, Y. B. Lee. C. Song, H, J. Hwang, J. H. Kim, T. Hyeon, ACS Nano 2015, 9, 6626, the contents of which are incorporated herein by references in their entirety.

The nanowires can have an average length of about 0.5-50 μm and an average diameter of about 10-500 nm. In some embodiments, the average length ranges from about 1 to about 40 pam or from about 5 to about 30 μm. In some embodiments, the average diameter ranges from about 25 to about 400 nm or from about 50 to about 300 nm. Each possibility represents a separate embodiment of the invention.

As mentioned hereinabove, the third layer of the polymer matrix comprises the third nanomaterial, which is configured to detect at least one of pressure, strain, temperature, pH, humidity, and volatile organic compounds (VOCs). The third layer, therefore, comprises a nanomaterial-based sensor. In some embodiments, said sensor is a piezoresistive sensor. In some embodiments, said sensor is a thermoresistive sensor. In some embodiments, said sensor is a chemiresistive sensor. The nanomaterial for the sensor can be chosen as known in the art, e.g., in U.S. Pat. No. 8,366,630. U.S. Pat. Nos. 9,696,311, 9,784,631 and WO 2020/039431, the contents of which are incorporated herein by reference in their entirety.

According to some embodiments, the third nanomaterial is selected from the group consisting of metallic nanowires, metallic nanoparticles capped with an organic coating, single walled carbon nanotubes (SWCNTs), carbon particles, conductive polymer, conductive polymer composite, ionic liquids, and combinations thereof.

The metallic nanowires and/or nanoparticles can be made of any suitable metals and metal alloys, as known in the art, including, inter alia, Au, Ag, Ni, Co, Pt, Pd, Cu, Al, Au/Ag, Au/Cu, Au/Ag/Cu, Au/Pt, Au/Pd, Au/Ag/Cu/Pd, Pt/Rh, Ni/Co, and Pt/Ni/Fe.

The coating of the conductive nanoparticles can comprise a monolayer or multilayers of organic compounds, wherein the organic compounds can be small molecules, monomers, oligomers or polymers, preferably with short polymeric chains. Non-limiting examples of suitable organic compounds include alkylthiols, arylthiols, alkylarylthiols, alkylthiolates, ω-functionalized alkylthiolates, arenethiolates, (γ-mercaptopropyl)tri-methyloxysilane, dialkyl sulfides, diaryl sulfides, alkylaryl sulfides, dialkyl disulfides, diaryl disulfides, alkylaryl disulfides, alkyl sulfites, aryl sulfites, alkylaryl sulfites, alkyl sulfates, aryl sulfates, alkylaryl sulfates, xanthates, oligonucleotides, polynucleotides, dithiocarbamate, alkyl amines, aryl amines, diaryl amines, dialkyl amines, alkylaryl amines, arene amines, alkyl phosphines, aryl phosphines, dialkyl phosphines, diaryl phosphines, alkylaryl phosphines, phosphine oxides, alkyl carboxylates, aryl carboxylates, dialkyl carboxylates, diaryl carboxylates, alkylaryl carboxylates, cyanates, isocyanates, peptides, proteins, enzymes, polysaccharides, phospholipids, and combinations and derivatives thereof.

The metal nanoparticles may have any desirable morphology including, but not limited to, a cubic, a spherical, and a spheroidal morphology. The mean particle size of the metal nanoparticles can range from about 1 to about 10 nm. The synthesized nanoparticles can be assembled (e.g., by a self-assembly process) to produce 1D wires or a film.

The term “single walled carbon nanotube” as used herein refers to a cylindrically shaped thin sheet of carbon atoms having a wall which is essentially composed of a single layer of carbon atoms which are organized in a hexagonal crystalline structure with a graphitic type of bonding. A nanotube is characterized by the length-to-diameter ratio. It is to be understood that the term “nanotubes” as used herein refers to structures in the nanometer as well as micrometer range.

The single-walled carbon nanotubes can have diameters ranging from about 0.5 nanometers (nm) to about 100 nm and lengths ranging from about 50 nm to about 10 millimeters (mm).

The nanotubes can be arranged in a random network configuration. In some embodiments, the network of SWCNTs can be fabricated by a physical manipulation or in a self-assembly process. The term “self-assembly”, as used herein, refers to a process of the organization of molecules without intervening from an outside source. The self-assembly process occurs in a solution/solvent or directly on a solid-state substrate.

The SWCNTs can be coated with polycyclic aromatic hydrocarbons (PAH) or derivatives thereof, such as hexa-peri-hexabenzocoronene (HBC) molecules. HBC molecules can be unsubstituted or substituted by any one of methyl ether (HBC-OC1), 2-ethyl-hexyl (HBC-C6,2), 2-hexyldecyl (HBC-C10,6), 2-decyltetradecyl (HBC-C14,10), and dodecyl (HBC-C12). In certain embodiments, the PAH is crystal hexakis(n-dodecyl)-peri-hexabenzocoronene (HBC-C12).

Non-limiting examples of suitable conducting polymers for use in the third layer include diketopyrrolopyrrole-naphthalene copolymer (PDPP-TNT), polydiketopyrrolopyrrole, polyaniline (PANI), polythiophene, poly(3,4-ethylenedioxythiophene)-poly(styrene-sulfonate) (PEDOT:PSS), polypyrrole, diketopyrrolopyrole-anthracene copolymer (PDPP-FAF), and derivatives and combinations thereof.

The term “conductive polymer composite”, as used in some embodiments, refers to a combination of a polymer which is not intrinsically conductive with electrically-conductive additives (e.g., carbon black, carbon nanotubes, metal flake, etc.).

Non-limiting examples of the conductive polymer composites include a disulfide polymer, a methacrylate polymer, and/or a polyethyleneimine polymer mixed with a carbon powder, e.g., carbon black or graphite. Non-limiting examples of carbon black suitable for use in the conductive polymer composites include acetylene black, channel black, furnace black, lamp black and thermal black. The disulfide polymer can be a self-healing polymer. In certain embodiments, the conductive polymer composite is selected from carbon black/PPGPUU, carbon black/PBPUU, carbon black/poly(propylene-urethaneureaphenyl-disulfide) composite, carbon black/poly(propylene-urethaneureaphenyl-disulfide)/poly(urethane-carboxyphenyl-disulfide) composite, and carbon black/poly(2-hydroxypropyl methacrylate)/polyethyleneimine composite.

In some exemplary embodiments, the third layer of the polymer matrix comprises at least one of AgNWs, semi-conducting SWCNTs, and carbon black/PPGPUU.

The self-healing polymer can be any type of a self-healing polymer as known in the art. In some embodiments, the self-healing polymer is a dynamic self-healing polymer. The term “dynamic”, as used herein, refers to dynamic crosslinking, i.e., to dynamic bonds formed between the polymeric chains of the polymer via suitable crosslinking bridges, which can be cleaved and reformed.

Non-limiting examples of dynamic bonds formed between the polymeric chains of the polymer via suitable crosslinking bridges include hydrogen bonds between hydrogen donating groups and hydrogen accepting groups, coordination bonds between cationic species, such as metal cations, and electron donating groups, electrostatic interactions between cationic groups and anionic groups, dynamic covalent bonds, such as the reversible formation of disulfide bonds and imine bonds, and (e) π-π interactions, such as between polycyclic aromatic groups or other π-π stacking interactions. Other examples of dynamic bonds include host-guest interactions, charge transfer interactions, and van der Waals interactions.

The dynamically cross-linked polymer can be formed of any type of polymeric molecules including suitable crosslinking bridges, which form the dynamic crosslinking. The dynamically cross-linked polymer can be formed from polymerization of one or more types of monomers. Polymeric molecules can be prepared synthetically, or can be derived from natural sources.

Preferably, the polymeric molecules should have sufficient flexibility to allow molecules near a damaged site to rearrange and bring their associative groups into close proximity, thereby allowing renewed crosslinking between the associative groups and self-healing. For example, the polymeric molecule can include a saturated hydrocarbon moiety, such as an alkylene moiety (e.g., an alkylene chain in the form of —(CH₂)ₙ with n in the range of 1 to 40, 1 to 20, or 1 to 10, wherein said alkylene chain can be functionalized with various functional groups). Additional non-limiting examples of a suitable polymeric molecule include polyurethane, polyurea, poly(urea-urethane), polyamide, polyester, polyimine, and polysiloxane chains. The polymeric molecule also can include a flexible portion attached to a relatively inflexible portion, such as an unsaturated hydrocarbon moiety or a cyclic moiety, provided the flexible portion imparts sufficient flexibility for self-healing. The polymers can also be copolymerized, for example, to combine soft and hard portions.

The self-healing polymer can include multiple crosslinking bridges per polymeric molecule, which can be same or different. For example, each polymeric molecule can include at least two crosslinking bridges, at least three, at least four, or at least five or more crosslinking bridges. The crosslinking bridges can be included in a backbone of the polymeric molecule, or can be pendant or terminal groups attached to the backbone.

Suitable crosslinking bridges can include sulfur, halogen, oxygen, nitrogen, and carbonyl-containing functional groups. In some embodiments, said crosslinking bridges include, inter-alia, sulfide, hydroxyl, amine, imine, amide, ester, urea, and carboxylic acid functional groups.

In certain embodiments, the self-healing polymer is hydrolytically stable. The term “hydrolytically stable”, as used herein, means that when the polymer is in contact with water, e.g., being placed in water or in environment with relative humidity of above about 70%, the polymer will not change its chemical composition through hydrolysis.

According to some embodiments, the self-healing polymer is hydrophobic. The term “hydrophobic”, as used herein, refers to any polymer resistant to wetting, or not readily wet by water. A hydrophobic polymer typically will have a water contact angle of at least about 90 degrees. In certain embodiments, the self-healing polymer has a water contact angle of at least about 100 degrees.

The self-healing polymer can be based on polyurethane. In some embodiments, the self-healing polymer is based on poly(urea-urethane). In further embodiments, the self-healing polymer is selected from the group consisting of polybutadiene-based poly(urea-urethane) (PBPUU), polypropylene glycol-based poly(urea-urethane) (PPGPUU), polyester-based poly(urea-urethane), and polyimide-based poly(urea-urethane). In further embodiments, said polyurethane- or (poly(urea-urethane)-based self-healing polymer comprises disulfide crosslinking bridges. Additional information on the PBPUU polymer can be found in WO 2020/245826, the content of which is incorporated herein by reference in its entirety.

In some embodiments, the first layer is encapsulated within an additional layer of the self-healing polymer, which separates the network of the first nanomaterial from the surrounding atmosphere.

In some embodiments, the third layer is encapsulated within an additional layer of the self-healing polymer, which separates the network of the third nanomaterial from the surrounding atmosphere.

The thickness of the first layer, the second layer, the third layer, and/or the additional layer can range from about 5 μm to about 500 μm. In some embodiments, the thickness of the first layer ranges from about 20 μm to about 200 μm. In some embodiments, the thickness of the second layer ranges from about 50 μm to about 300 μm. In some embodiments, the thickness of the third layer ranges from about 50 μm to about 200 μm. In some embodiments, the thickness of the additional layer ranges from about 100 μm to about 300 μm.

The thickness of the composite material can range from about 10 μm to about 1000 μm. In some embodiments, the thickness of the composite material ranges from about 100 μm to about 700 μm. The thickness of the sensing platform unit can range from about 20 μm to about 2000 μm. In some embodiments, the thickness of the platform unit ranges from about 300 μm to about 1000 μm.

In some embodiments, the first layer, the second layer, or both further comprise at least two electrodes electrically connected to the network of the first nanomaterial and/or the network of the second nanomaterial, and to the mutual control circuit.

The term “electrode”, as used herein, refers to any terminal that conducts an electric current into or away from a conducting medium. In some embodiments, the term “electrode” includes conductive wires or traces that electrically connect the network of the first nanomaterial and/or the network of the second nanomaterial to the mutual control circuit.

In some embodiments, the second layer comprises at least two electrodes electrically connected to the network of the second nanomaterial, and to the mutual control circuit. According to some embodiments, each one of the first layer and the second layer further comprises at least two electrodes electrically connected to the network of the first nanomaterial and the network of the second nanomaterial, respectively, and to the mutual control circuit.

In some embodiments, the network of the first nanomaterial comprises a continuous pathway of the first nanomaterial. In further embodiments, said pathway is a single electrically conducting pathway between the two electrodes.

According to some embodiments, the first nanomaterial covers at least about 5% of the total area occupied by its network. In additional embodiments, the first nanomaterial covers at least about 10% of the total area, at least about 20%, or at least about 30%. Each possibility represents a separate embodiment of the invention.

In some embodiments, the network of the second nanomaterial has a random network configuration of the second nanomaterial. According to some embodiments, the second nanomaterial covers at least about 20% of the total area occupied by its network. In additional embodiments, the second nanomaterial covers at least about 30% of the total area, at least about 40%, or at least about 50%. Each possibility represents a separate embodiment of the invention.

In further embodiments, the random network of the second nanomaterial is disposed between the at least two electrodes. In yet further embodiments, said network covers at least about 20% of the surface confined by the at least two electrodes. In additional embodiments, the network of the second nanomaterial covers at least about 30% of the surface confined by the at least two electrodes, at least about 40%, at least about 50%, at least about 7′5% or at least about 90%. Each possibility represents a separate embodiment of the invention.

According to some embodiments, the third layer further comprises at least two electrodes electrically connected to the network of the third nanomaterial.

The electrodes can be made of any electrically conductive material, as known in the art. In some embodiments, the electrical conductivity of the electrodes is essentially equal to or higher than the electrical conductivity of the second nanomaterial. In certain such embodiments, the heater has a higher resistance than the interconnects in order to concentrate the heat on the desirable specific areas. In some exemplary embodiments, the electrodes comprise AgNWs. In additional exemplary embodiments, the electrodes comprise copper. In certain embodiments, the second layer comprises electrodes made of copper.

The electrodes can have any geometrical shape, as known in the art, such as, but not limited to, rectangular or strip shape. In certain embodiments, the electrodes further comprise a connection pad. The electrodes can comprise patterned electrodes, for example, interdigitated electrodes. The interdigitated electrodes can have any shape, as known in the art, such as, but not limited to rectangular or circular shapes.

According to some embodiments, the first layer is disposed on top of the second layer. According to further embodiments, the network of the first nanomaterial and the network of the second nanomaterial are disposed at the same vertical location of the composite material. The term “same vertical location”, as used herein, refers to a location along the same vertical axis. Accordingly, in certain such embodiments, the network of the first nanomaterial is disposed on top of the network of the second nanomaterial. According to some embodiments of the self-repair sensing platform unit, the first layer is disposed between the second layer and the third layer.

The first layer can comprise a plurality of networks of the first nanomaterial. The second layer can comprise a plurality of networks of the second nanomaterial. In some related embodiments, positions of the plurality of networks of the first nanomaterial along the first layer are aligned with the positions of the plurality of networks of the second nanomaterial along the second layer.

In some embodiments, the third layer comprises a plurality of networks of the third nanomaterial. In some related embodiments, positions of the plurality of networks of the first nanomaterial along the first layer are aligned with the positions of the plurality of networks of the second nanomaterial along the second layer and, with the positions of the plurality of networks of the third nanomaterial along the third layer.

According to further embodiments, the network of the first nanomaterial, the network of the second nanomaterial, and the network of the third nanomaterial are disposed at the same vertical location of the composite material.

According to some embodiments, each network of the plurality of networks of the first nanomaterial is associated with a respective network of the plurality of networks of the second nanomaterial. In further embodiments, the mutual control circuit is configured to apply voltage to any network of the plurality of networks of the second nanomaterial upon a change in the resistance of the respective network of the plurality of networks of the first nanomaterial.

As mentioned hereinabove, the mutual control circuit is configured to apply voltage to the second nanomaterial upon a change in resistance of the first nanomaterial. The term “apply voltage” is meant to encompass any action, which induces flow of current within the second nanomaterial network.

The mutual control system can be further configured to measure the resistance of the first nanomaterial network. In some embodiments, the mutual control system is further configured to continue to apply voltage to the second nanomaterial until the resistance of the first nanomaterial returns to the baseline level. In some embodiments, the mutual control system is configured to continue to apply voltage to the second nanomaterial until the resistance of the first nanomaterial drops below about 500% of the baseline level, below about 300%, below about 200%, or below about 120% of the baseline level. Each possibility represents a separate embodiment of the invention. In some embodiments, the mutual control system is configured to suspend application of the voltage once the resistance of the first nanomaterial returns to the baseline level or drops below about 500% of the baseline level, below about 300%, below about 200%, or below about 120% of the baseline level. Each possibility represents a separate embodiment of the invention.

According to some embodiments, the mutual control circuit comprises a processor, selected from a microprocessor, a microcontroller, a Digital Signal Processor (DSP), an Application Specific Integrated Circuit (ASIC), a Field Programmable Gate Array (FPGA), a Programmable Logic Device (PLD), PLC, a controller, a state machine, gated logic, discrete hardware components, or any other suitable device or a combination of devices that can perform calculations or other manipulations of information. Each possibility represents a separate embodiment.

The term “processor”, as used herein, refers to a single chip device which includes a plurality of modules which may be collected onto a single chip in order to perform various computer-related functions.

According to some embodiments, the first and the second nanomaterials are configured to communicated with the mutual control circuit utilizing wired or wireless communication (e.g., Wi-Fi or Bluetooth).

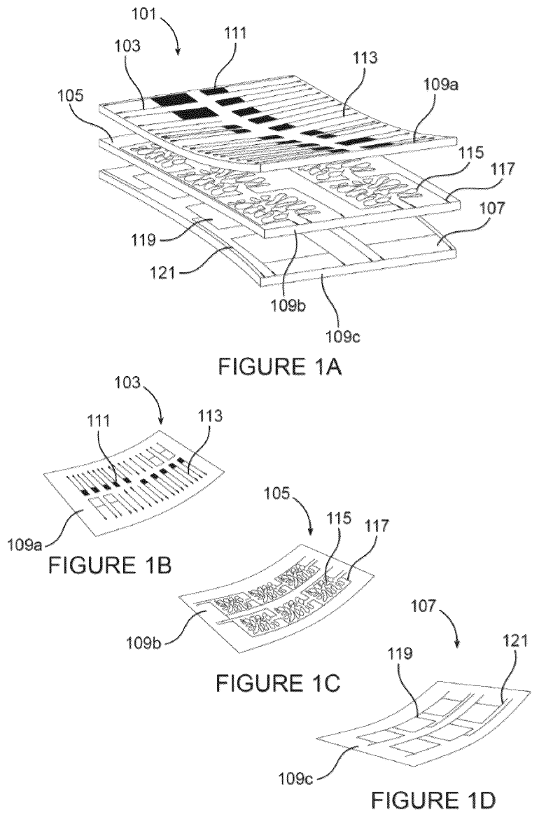

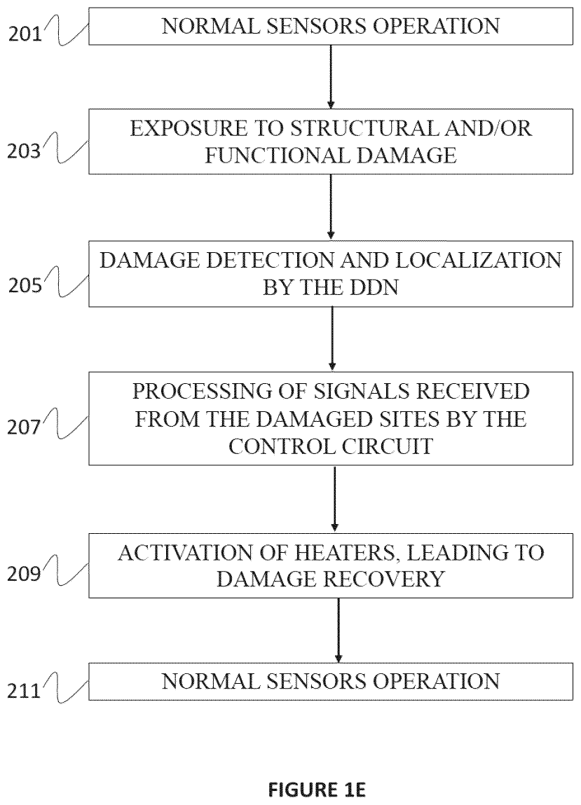

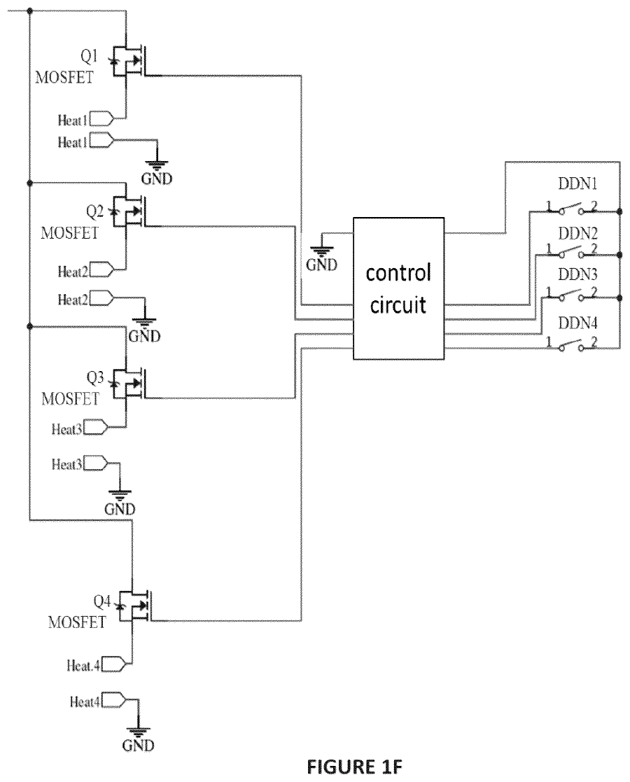

Reference is now made to FIGS. 1A-1D, which schematically illustrate self-repair sensing platform unit 101 (also termed herein “e-skin”), in accordance with some embodiments of the invention. Damage detection and self-repair mechanism provided by self-repair sensing platform unit 101 is explained in FIG. 1E. The self-repair sensing platform unit is designated to have fast, highly efficient and autonomous monitoring of self-healing processes under harsh environmental conditions, for small- and big-scale damage and cuts, including, inter alia, in complex humidity and/or underwater conditions. This target is achieved by mimicking several aspects of human skin properties and functions. Normal functionality of the skin such as sensing environmental signals can be interrupted by the exosure of the skin to structural and functional damage, which is then followed by damage detection and localization, processing of signals received from the damaged sites, and activation of specialized repair systems, leading to damage recovery.

The composite material and the sensing platform unit of the present invention are characterized by the multilayer structure based on the polymer matrix. The two layeres of the composite material introduce a controlled feedback system that selectively accelerates the self-healing process at designated locations. The first part of this system relies on detecting and mapping any structural damage using resistive neuron-like or ribbon-like nanostructured pathways. The second part relies on the activation of a repairing system; in a similar manner to repair mechanisms found in human body that facilitate and accelerate the recovery of damage and on deactivation of the repair process after full or partial recovery—once the damage has been fixed, a signal is sent back to the control system that deactivates the repair process. The top layer contains multiple sensors for detecting enviometnal signals. When damaged, the sensors are repaired by the controlled feedback and repair system provided by the two underlying layers.

Three-layer sensing platform unit 101 comprises top sensing layer 103 (shown separately in FIG. 1B), middle damage detection layer 105 (shown separately in FIG. 1C) and bottom self-repair layer 107 (shown separately in FIG. 1D). Layers 105 and 107, as combined, constitute the composite material according to the aspects and embodiments of the present invention. Top layer 103 comprises self-healing polymer 109a, middle layer 105 comprises self-healing polymer 109b, and bottom layer 107 comprises self-healing polymer 109c. Top layer 103 further contains sensors 111 and interconnects 113 embedded within or disposed upon self-healing polymer 109a. Middle layer 107 further contains a plurality of DDNs 115 and electrodes 117. DDN 115 comprises a network of a first nanomaterial which resistance changes in response to a mechanical damage inflicted on self-healing polymer 109b. DDNs 115 are embedded within or disposed upon self-healing polymer 109b. Each DDN 115 is connected to two electrodes 117. Bottom layer 107 further contains a plurality of heaters 119 for repairing damage inflicted on sensing platform unit 101, and electrodes 121. Heater 119 comprises a network of a second nanomaterial configured to generate heat under applied voltage. Heaters 119 are embedded within or disposed upon self-healing polymer 109c. Each heater 119 is disposed between two electrodes 121. DDNs 115 and heaters 119 are electrically connected to a mutual control circuit (FIG. 1F). The control circuit is configured to apply voltage to heater 119 upon a change in resistance of DDN 115, which is disposed directly above said heater. This way, damaged sensing platform unit can be locally repaired by a DDN-heater pair (or a plurality DDN-heater pairs) located within the damaged region.

Self-repair system layer 107 is preferably the deepest layer in order to make it less sensitive to external damage—thereby increasing its durability. Preferably, DDN layer 105 is located as close as possible to sensing layer 103 to allow efficient detection of damage.

FIG. 1E shows the mode of operation of sensing platform unit 101. When normal sensors operation (201) is interrupted by the sensors' exposure to structural and/or functional damage (203), damage and its location are detected by the DDN (205) and signals received from the damaged sites are processed by the control circuit (207). Then the heaters are activated, leading to damage recovery (209) and normal sensors' operation is resumed (211).

In some exemplary embodiments, the composite material comprises a self-healing polymer comprising PBPUU, a network of the first nanomaterial comprising carbon black and the network of the second nanomaterial comprising AgNWs. In further embodiments, the network of the first nanomaterial is arranged in a continuous conductive pathway. In yet further embodiments, the network of the second nanomaterial has a random configuration.

In some exemplary embodiments, the sensing platform unit comprises a self-healing polymer comprising PBPUU, a network of the first nanomaterial comprising carbon black and the network of the second nanomaterial comprising AgNWs. In further embodiments, the network of the first nanomaterial is arranged in a continuous conductive pathway. In yet further embodiments, the network of the second nanomaterial has a random network configuration. In still further embodiments, the sensing platform unit comprises the network of the third nanomaterial comprising at least one of AgNWs, semi-conducting SWCNTs, and carbon black-PPGPUU composite. In yet further embodiments, the sensing platform unit comprises at least one of a temperature, pressure, and pH sensors, which are formed by AgNWs, semi-conducting SWCNTs, and/or carbon black-PPGPUU composite. According to certain exemplary embodiments, the third layer of the sensing platform unit comprises at least one of a temperature sensor comprising AgNWs, pressure sensor comprising AgNWs and carbon black-PPGPUU composite, and a pH sensor comprising AgNWs and semi-conductive SWCNTs. According to some exemplary embodiments, the third layer of the sensing platform unit comprises a temperature sensor comprising AgNWs, pressure sensor comprising AgNWs and carbon black-PPGPUU composite, and a pH sensor comprising AgNWs and semi-conductive SWCNTs.

The self-repair composite material and the platform unit can be prepared by forming each one of the first layer, the second layer and, optionally, the third layer separately and combining them to form a single unit. The first layer, the second layer, and/or the third layer can be prepared by forming the network of the respective nanomaterial on a suitable substrate, e.g., by drop-casting or spraying a dispersion of the nanomaterial and forming a layer of the self-healing polymer upon said substrate and the nanomaterial network, followed by peeling off the polymer with the nanomaterial network from the substrate. The dispersion of the nanomaterial can be applied to the substrate via a mask with a predetermined pattern. The preparation process can further include a step of forming at least two electrodes per each nanomaterial network. The combined layers can be further covered with an additional layer of the self-healing polymer to protect the network of the first nanomaterial or the third nanomaterial.

The self-repair composite material and sensing platform unit according to the various embodiments of the present invention can be used in disparate technological fields, and in particular, in soft electronics applications, ranging from wearable devices and electronic skins for prosthetics and robotics to marine soft electronic.

In some embodiments, the second layer is configured to contact the surface to which the composite material is attached and the first layer is configured to face outwards.

In some embodiments, the second layer is configured to contact the surface to which the sensing platform unit is attached and the third layer is configured to face outwards.

As used herein and in the appended claims the singular forms “a”, “an,” and “the” include plural references unless the content clearly dictates otherwise. Thus, for example, reference to “an electrode” can include a plurality of such electrodes and equivalents thereof known to those skilled in the art, and so forth. It should be noted that the term “and” or the term “or” is generally employed in its sense including “and/or” unless the content clearly dictates otherwise.

As used herein, the term “about”, when referring to a measurable value such as an amount, a temporal duration, and the like, is meant to encompass variations of +/−10%, more preferably +/−5%, even more preferably +/−1%, and still more preferably +/−0.1% from the specified value, as such variations are appropriate to perform the disclosed methods.

The following examples are presented in order to more fully illustrate some embodiments of the invention. They should, in no way be construed, however, as limiting the broad scope of the invention. One skilled in the art can readily devise many variations and modifications of the principles disclosed herein without departing from the scope of the invention.

### EXAMPLES

### Example 1—Fabrication of the Self-Repair Composite Material and Platform Sensing Unit Components

### Materials

All solvents were received from commercial sources and used as received. Hydroxyl terminated polybutadiene (HTPB, Mn 2300) was purchased from Shanghai ZZ New Material Tech. Co., Ltd. Isophorone diisocyanate (IPDI, 98%), Dibutyltin dilaurate (DBTDL, 95%), Poly(propylene glycol) tolylene 2,4-diisocyanate terminated (PPG-TDI, Mn 2300), 4-aminophneyl disulfide (APDS, 98%), Iron(III) chloride, and Triton X-100 were obtained from Sigma-Aldrich. Carbon nanotubes (CNTs) for electrodes (>75%) were purchased from TUBALL and dispersed in water. PDMS (SYLGARD® 184) was obtained from Sigma Aldrich. Silver nanowires (AgNWs) were synthesized according to a previously reported method (J. Ma and M. Zhan, Rapid production of silver nanowires based on high concentration of AgNO₃ precursor and use of FeCl₃ as reaction promoter. RSC Adv. 4, 21060-21071 (2014)). Acidic aqueous solutions were prepared using different concentrations of HCl while basic solutions were prepared using NaOH.

Preparation of PBPUU and PPGPUU: PBPUU (polybutadiene-based poly(urea-urethane) with disulfide bridges) was prepared using a previously reported method (Rekondo, Alaitz, et al. “Catalyst-free room-temperature self-healing elastomers based on aromatic disulfide metathesis.” Materials Horizons 1.2 (2014): 237-240). In brief, HTPB (2.3 g, 1 mmol) was dried in vacuum oven at 80° C. for 2 hr to remove any moisture and then cooled to 80° C. IPDI (445 mg, 2 mmol) and DBTDL (5 mg, ˜1600 ppm) dissolved in THF (10 mL) were added dropwise into the vessel and stirred for 1.5 h under a N₂ atmosphere. After the synthesis of the pre-polymer, APDS (250 mg, 1 mmol) dissolved in THF (5 mL) was added to the reactor as a chain extender. After 36 hr, the reaction was stopped with the addition of excess of methanol (0.5 ml) into the mixture and mixed for additional 12 hr. After that, MeOH (50 mL) was added for precipitation of the product. Yellow precipitate-like viscous liquid appeared and the mixture was settled for 30 minutes. The upper clear solution was then decanted. 15 mL THF was added to dissolve the product. The dissolution-precipitation-decantation process was repeated for three times and the final product was subjected to vacuum to remove the solvent and other traces of reactants. PPGPUU (polypropylene glycol-based poly(urea-urethane with disulfide bridges) was prepared by mixing PPG-TDI and APDS (1:1.05 molar ratio) in THF. The mixture was casted, dried, and then heated to 70° C. for 24 hr.

Fabrication of the self-healing heater: a dispersion of AgNWs (having 250 nm average diameter and 150 μm average length) was sprayed through a shadow-mask on a slightly modified silicon wafer, prepared by treatment with oxygen plasma and then immersion in a solution of hexyltrichlorosilane in toluene for 1 min. PBPUU solution (100 mg/ml) in chloroform was drop-casted on the AgNWs network and left to dry and then peeled off. Finally, another PBPUU layer (200 μm) was transferred on top for insulation. Copper tape was used later for electrical connections.

Fabrication of the self-healing damage detecting network (DDN): a dispersion of carbon black (having 40 nm mean particle size) in chloroform was sprayed through a shadow-mask on a slightly modified silicon wafer, prepared by treatment with oxygen plasma and then immersion in a solution of hexyltrichlorosilane in toluene for 1 min. PBPUU solution (100 mg/ml) in chloroform was drop-casted on the CB network and left to dry and then peeled off. Finally, another PBPUU layer (200 μm) was transferred on top for insulation from water.

Preparation of the self-healing temperature sensor: AgNWs dispersion was sprayed through a shadow-mask on a slightly modified silicon wafer, prepared by treatment with oxygen plasma and then immersion in a solution of hexyltrichlorosilane in toluene for 1 min. PBPUU solution (100 mg/ml) in chloroform was drop-casted on the AgNWs network and left to dry and then peeled off. Another PBPUU layer (200 μm) was transferred on top for insulation from water.

Preparation of the self-healing pressure sensor: AgNWs dispersion was sprayed through a shadow-mask on a slightly modified silicon wafer, prepared by treatment with oxygen plasma and then immersion in a solution of hexyltrichlorosilane in toluene for 1 min. PBPUU solution (100 mg/ml) in chloroform was drop-casted on the AgNWs network and left to dry and then peeled off. CB-PPGPUU composite ink (1:1 by mass) was casted/sprayed on the AgNWs network, and finally another PBPUU layer (200 μm) was transferred on top for insulation from water.

Preparation of the self-healing water-gated transistor: For electrode (source drain and gate) preparation, AgNWs dispersion was sprayed through a shadow-mask on a slightly modified silicon wafer, prepared by treatment with oxygen plasma and then immersion in a solution of hexyltrichlorosilane in toluene for 1 min. PBPUU solution (100 mg/ml) in chloroform weas drop-casted on the electrodes and left to dry and then peeled off. Semi-conductive CNT ink was prepared by mixing 99% semi-conducting-SWCNT solution, DI-water, propylene glycol and FluroN at the ratio of 1:6:1.25:0.75 (by volume), followed by ultrasonication. Subsequently, semi-conductive CNT ink (10 μL) was drop-casted on the source/drain composite electrodes after treatment with oxygen plasma and heated to 90° C. for 30 min. The obtained structure was rinsed in DI water for 1 hr to remove the surfactants, and then left in a vacuum oven at 90° C. for several hours. An insulation layer of PBPUU was coated on top of the transistor leaving the semi conductive channel and the adjacent gate electrodes exposed. For the preparation of solid thin Ag/Cl reference electrode, FeCl₃ in water was dropped on the gate electrode for 30 seconds and then was covered with NaCl/PVB layer.

Fabrication of the Self-Healing Multilayered Structures (Composite Material and Sensing Platform Unit):

The composite material was built by transfer printing of the DDN layer upon the heater layer and encapsulating the obtained structure with a final encapsulation layer above the DDN layer.

The sensing platform unit was built by transfer printing of the 3 layers one by one in addition to the final encapsulation layer. The sensors layer (including pressure sensor, temperature sensor, and pH sensor) was disposed above the DDN layer and the DDN was disposed above the heater layer. The use of self-healing materials leads to a very good adhesion between the different layers and prevents delamination problems (which is highly important for underwater electronics). The bottom layer and the encapsulation layer have a thickness of ˜ 200 μm while the other two layers are 100 μm thick leading to a total thickness of the sensing platform unit of about 600 μm.

Damage detection and heater activation: FIG. 1F shows a circuit diagram of the electrical connection of the multiple components of the sensing platform unit. The control circuit was an ARDUINO Chip. When the DDN is damaged, its resistance significantly increases. The resistance of the DDN is measured by an ARDUINO chip. When the resistance rises above a predetermined threshold, the ARDUINO chip closes the switch of the heater circuit, effectively turning on the corresponding heater. When the resistance drops below said threshold, then the ARDUINO chip opens the switch, hereby turning off the heater.

### Example 2—Characterization Methods

Electrical and mechanical characterizations: Two-point resistance measurements were done on the AgNWs electrodes with a Keithley (model 2701 DMM). For the tape test, the resistance was measured before and after repetitive attachment and slow peeling off a scotch tape from the sample.

Self-healing tests: Self-healing processes were monitored using an optical microscope (BX51M, Olympus) with integrated camera (LC20, Olympus). Electrical self-healing characterization of the AgNWs-based components was done by 2-point resistance using a Keithley data logger device (model 2701 DMM), controlled by a custom LabVIEW program; this allowed us to acquire sequential resistance readings from the AgNWs conductive films. Cutting was done with a ˜20 m blade or >1 m razor-sharp blade. For a more precise damage, >1 m razor-sharp blade was connected to a motorized test stand (MARK 10 ESM301), and then varying cuts were made by applying specific force. Precise cuts of 100 gf were used for studying the recovery of the self-healing sensors (pressure, temperature, and pH).

Temperature sensor characterization: The sensors were immersed in water; the resistance was monitored while changing the temperature of the solution.

Pressure sensor characterization: A MARK 10 ESM301 motorized test stand was used to apply pressure on the sensors that were encapsulated with PBPUU and attached to a PDMS soft stage. The forces were measured by an advanced digital force gauge made by Mark10, USA. In these experiments, the electrical resistance was measured by a Keithley data-logger device (model 2701 DMM) controlled by a custom LabVIEW program.

pH sensor characterization: The sensors were immersed in water; for the pH sensors, the transfers curves were measured under varying pH values. For pressure and temperature sensors, the resistance was monitored while changing the pH of the solution by adding concentrated NaOH or HCl solutions.

### Example 3—PBPUU Polymer Matrix and AgNWs-Based Electrodes

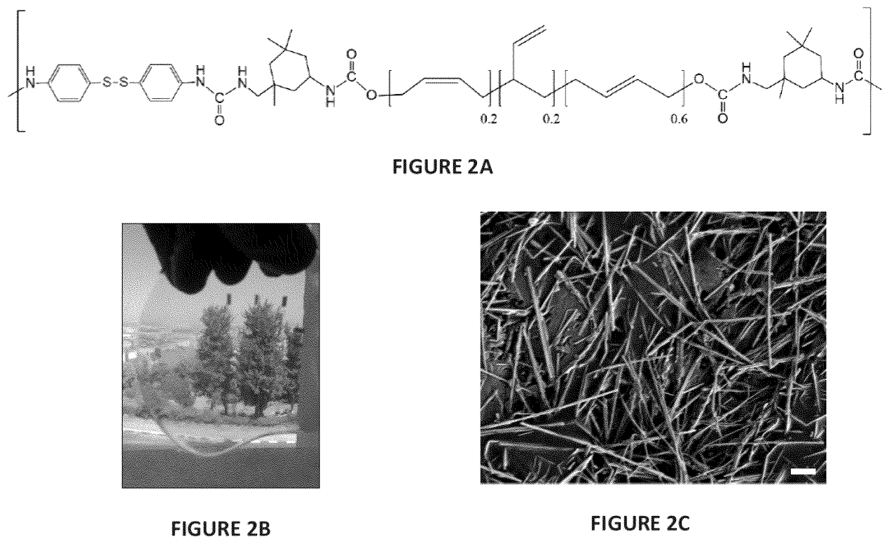

All the three layers comprise a dynamic self-healing polymer, PBPUU (FIGS. 2A and 2B), which was shown to be hydrolytically stable, thus being a superior candidate for building electronic skin devices. All the electrical components of the e-skin are entirely composed of PBPUU and nanostructured conductive fillers. Without wishing to being bound by theory or mechanism of action, this strategy is crucial for integrating softness and intrinsic self-healing ability in all electronic components.

Silver nanowires (AgNWs) were embedded onto the surface of PBPUU to obtain highly soft and self-healing electrodes (FIG. 2C).

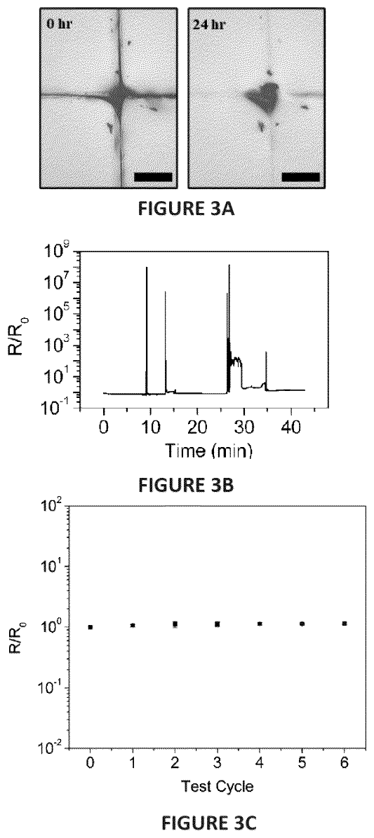

The PBPUU polymer was shown to have a tensile strength of ˜6.5 MPa besides its efficient self-healing capability in a wide variety of underwater conditions including tap water, sea water, and water with different pH values (FIG. 3A). It was also able to eliminate any electrical leakages caused by underwater damages.

AgNWs were embedded onto the surface of PBPUU to obtain highly soft and self-healing electrodes. Self-healing of the AgNW-electrode under varying manual blade-cuts is shown in FIG. 3B. The connection between the AgNWs and PBPUU was strong enough showing almost no change after repeatetive tape tests (FIG. 3C).

### Example 4—AgNWs-Based Heaters and CB-Based DDNs

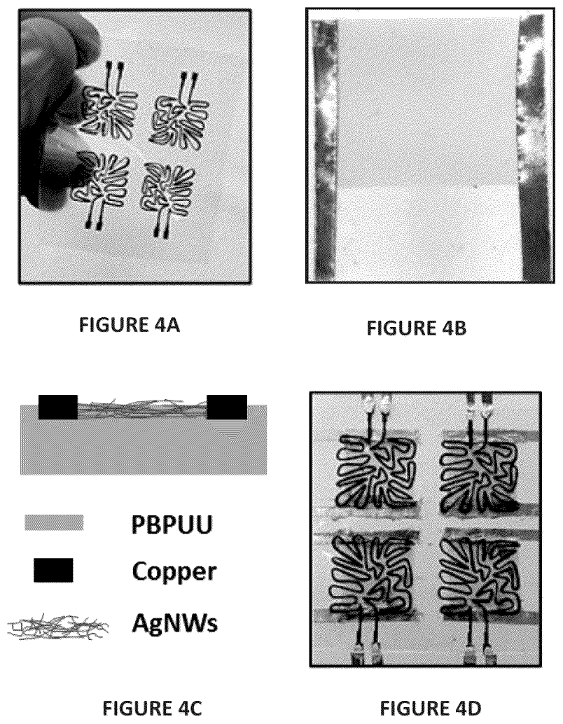

A neuron-like nanostructured network of conductive carbon black (CB) embedded inside PBPUU was used for mapping and determining local damage (said network being the DDN). The design strategy of the DDN is reversible due to the reconstruction of the resistive pathways after healing (FIG. 4A).

Accelerated recovery of the detectable damaged parts is achieved by the integration of an array of self-healing electrical heaters that selectively/locally apply heat to damaged areas, leading to very efficient acceleration of repair. The heaters were composed of an AgNW network embedded within PBPUU (FIGS. 4B and 4C). The composite material comprising a top layer containing DDNs and a bottom layer containing heaters is shown in FIG. 4D.

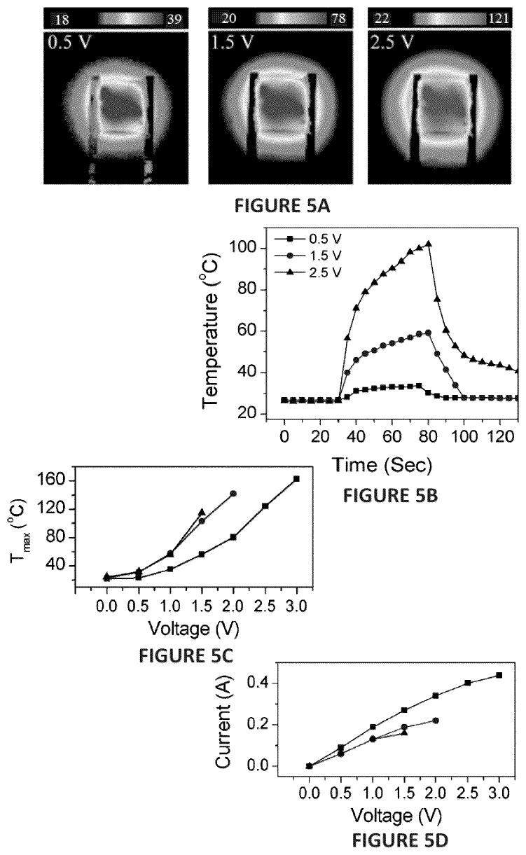

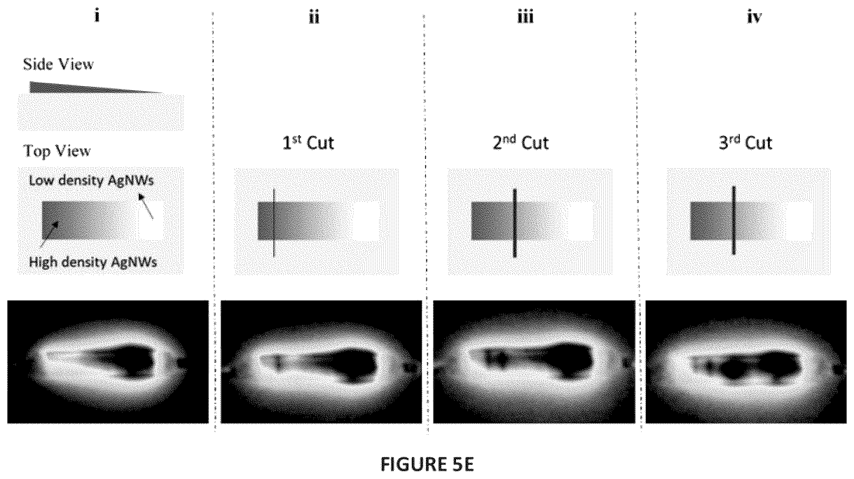

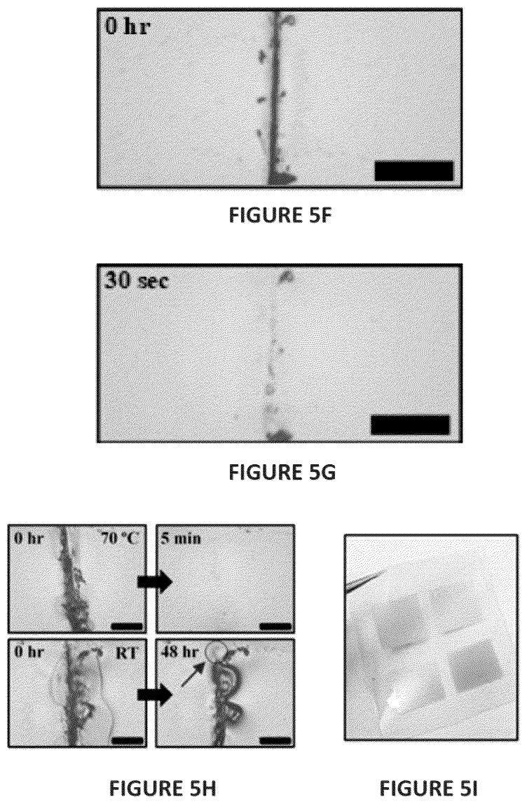

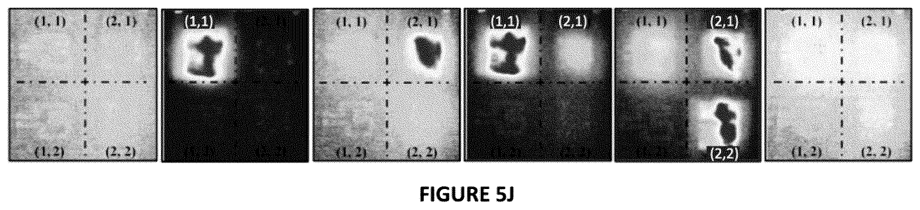

The AgNW-based heaters were tested under different voltages and showed efficient heating capabilities at a very low voltage (FIGS. 5A and 5B). Of special interest, both the heater and the DDN were intrinsically self-healing, which is highly advantageous for the survivability of the entire composite material. The intrinsic self-healing of the heater is demonstrated in FIGS. 5C-5D, which shows a comparison between the operation of the heater, in terms of the maximum temperature and the heater current, before and after the recovery of surface cuts. Interestingly, a partially healed heater (intrinsic healing) leads to heat localization close to the damaged area, which is highly beneficial in accelerating recovery compared to a non-active heater (FIG. 5E). This repair process leads to the healing of superficial crack in 30 sec instead of 24 h (FIGS. 5F-5G), and 5 min in the case of widespread damage, which could not be recovered even after 48 h under ambient conditions (FIG. 5H), upon heating to 70° C. Without wishing to being bound by theory or mechanism of action, this very fast and efficient self-healing is obtained due to the increased mobility of PBPUU chains and faster surface rearrangment at higher temperatures. The operation of the entire self-repair composite material by using 4 controlled regions equipped with 4 DDNs and 4 heaters has been demonstrated (FIGS. 5I, 3C, and 3D). FIG. 5J shows the activation/deactivation of the corresponding heater following surface damage.

### Example 5—Nanomaterial-Based Sensors

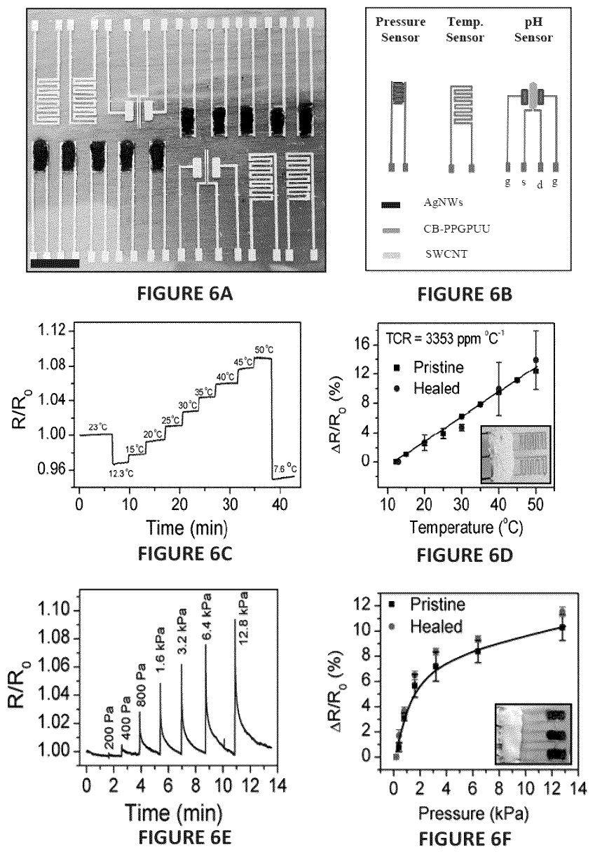

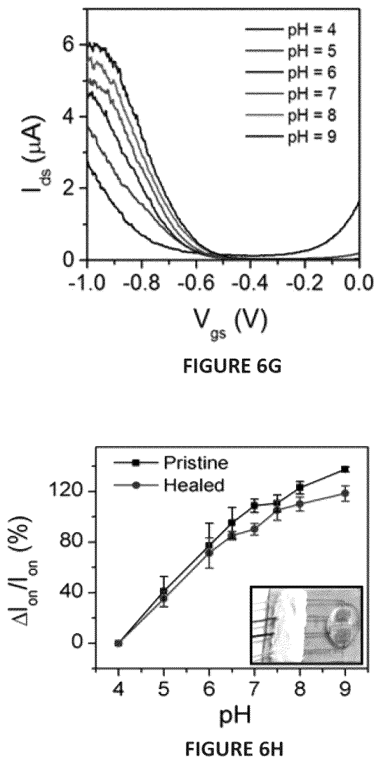

The capability of the sensing platform unit manufactured as described in Example 1 to operate as a multifunctional sensing system as well as to distinguish between different physical and chemical stimuli has been investigated. These features are very important for obtaining human-like interaction with the environmental signals, including temperature and pressure. The sensing platform unit, therefore, included temperature, pressure and pH sensors. FIGS. 6A and 6B show the sensing layer of the sensing platform unit and the specific structure of each sensor.

For temperature sensing, a resistive pattern of AgNWs embedded in PBPUU was used. The use of AgNWs for temperature sensors is based on the thermoresistive effect. Changes in resistance were recorded as a function of temperature change (FIG. 6C). Very good sensitivity was achieved, with a temperature coefficient of resistance (TCR) of ˜3,353 ppm° C.⁻¹, both before and after the recovery of structural damage (FIG. 6D).

For pressure sensing, a resistive sensor based on a composite of PPGPUU and carbon black (CB) was used. The application of pressure leads to an increased distance between the conductive fillers, and therefore to an increase in resistance (FIG. 6E). This composite was very sensitive to pressures as low as 200 Pa and has shown a highly recoverable sensitivity before and after self-healing (FIG. 6F).

For pH detection, PBPUU-based ultralow voltage water-gated transistors for underwater sensing were used (FIG. 6G). Single-walled carbon nanotubes (SWCNTs) were employed as the sensing layer. This type of platform is important because it can be used for versatile sensing applications, including physical and electrochemical sensors, e.g., biological sensors that can selectively detect biomolecules using specific functional receptors. The device was used to detect differences in the pH, showing higher on-currents under basic conditions than under acidic conditions. Without wishing to being bound by theory or mechanism of action, this ability is related to the change in the electrical properties of CNTs due to a change in the pH. It has also been shown that there has been no noticeable difference in sensitivity of the sensors after damaging the electrodes (FIG. 6H).

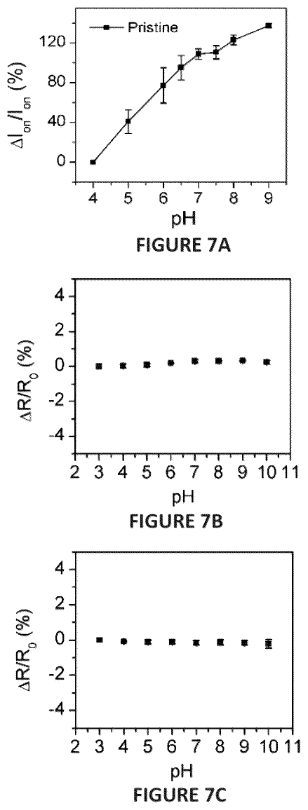

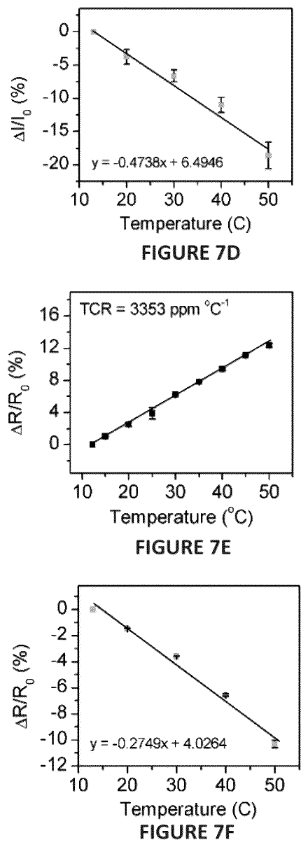

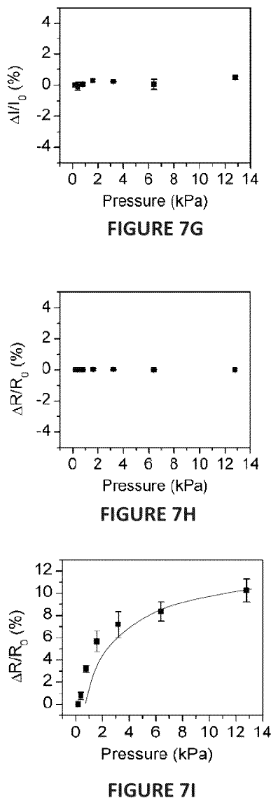

Sensitivity of each sensor toward other signals was analyzed. FIGS. 7A-7I show the great selectivity obtained towards the sensor's corresponding signal. It has also been shown that each sensor has a minimal change in its response when exposed to other interfering signals.

### Example 6—Operation of the Self-Repair Platform Sensing Unit

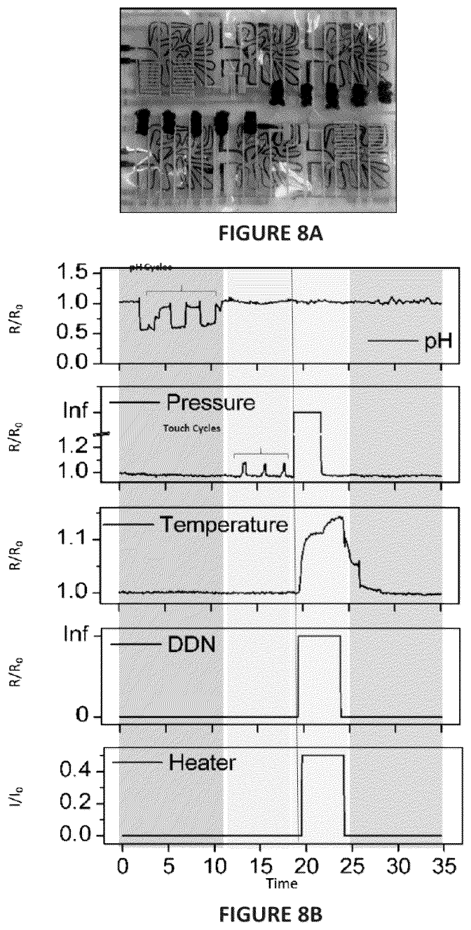

Operation of the integrated highly autonomic sensing platform unit has been demonstrated (FIG. 8A). The entire sensing platform unit (or e-skin) has been composed of a multilayered structure including: (1) the top layer containing sensors and interconnects; (2) a layer for detecting structural damage, leading to activation of a self-repair mechanism; (3) bottom layer composed of heater arrays for repairing large-scale damage. The combination of the intrinsic self-healing, which is highly efficient for small scale repair and designed to be highly water-insensitive, with an advanced and efficient damage-activated self-repair system, would be very useful for the survivability of the whole electronic system. In the case of a small-scale damage (<100 μm in depth), which only inflicts the upper layer, the intrinsic self-healing capability can operate alone until recovery; however, once the damage is large enough (>100 μm in depth) to be sensed by the DDN, both the intrinsic self-healing and the self-repair mechanism will operate until recovery. Said smart design of the repair system can be easily implemented in electronic devices using simple structures and components, something that is missing in passive materials that have no electronic properties. A demonstration of the operation of the entire multi-layered e-skin is documented in FIG. 8B. Starting from the pH and pressure sensors, there were 3 cycles of pH change between 4 and 8 and 3 cycles of touch sensing. Then, a blade cut was made on the area of the pressure sensor damaging both the sensor itself and the DDN beneath it. This led to the activation of the heater that increased the local temperature. The adjacent temperature sensor (undamaged) detected the increase in temperature. Temperature detection can be beneficial for controlling the extent of heating, e.g., by providing a feedback regarding the maximum temperatures obtained by the heaters, thereby allowing safe operation under a specified range of temperatures that does not lead to mechanical/chemical degradation. Finally, the DDN and pressure sensors were recovered, leading to the deactivation of the heater, and a decrease in the local temperature. This design represents a huge step in the field of biomimetic electronics toward fully autonomous systems.

It is appreciated by persons skilled in the art that the present invention is not limited by what has been particularly shown and described hereinabove. Rather the scope of the present invention includes both combinations and sub-combinations of various features described hereinabove as well as variations and modifications. Therefore, the invention is not to be constructed as restricted to the particularly described embodiments, and the scope and concept of the invention will be more readily understood by references to the claims, which follow.

1-39. (canceled)

40. A composite material comprising:
a self-healing polymer matrix and at least two conductive nanomaterials embedded therein,
wherein the polymer matrix has a multi-layer structure comprising:
a first layer comprising a network of a first nanomaterial, which resistance changes in response to a mechanical damage inflicted on the polymer matrix; and
a second layer comprising a network of a second nanomaterial, configured to generate heat under applied voltage,
wherein the network of the first nanomaterial and the network of the second nanomaterial are electrically connected to a mutual control circuit which is configured to apply voltage to the network of the second nanomaterial upon a change in resistance of the network of the first nanomaterial.

41. The composite material according to claim 40, wherein the first layer is disposed on top of the second layer, or wherein the first layer is disposed on top of the second layer and the network of the first nanomaterial and the network of the second nanomaterial are disposed at the same vertical location of the composite material.

42. The composite material according to claim 40, wherein the first nanomaterial is selected from the group consisting of a carbonaceous material, a metal, a conductive polymer, and combinations thereof; or wherein the first nanomaterial is a carbonaceous material selected from the group consisting of carbon black nanoparticles, carbon nanotubes (CNTs), graphene, and combinations thereof: or wherein the first nanomaterial comprises carbon black nanoparticles.

43. The composite material according to claim 40, wherein the network of the second nanomaterial is a percolation network; or wherein the second nanomaterial comprises metallic nanowires; or wherein the second nanomaterial comprises metallic nanowires selected from the group consisting of silver nanowires (AgNWs), gold nanowires (AuNWs), copper nanowires (CuNWs), and combinations thereof.

44. The composite material according to claim 40, wherein the self-healing polymer comprises polymeric chains selected from the group consisting of polybutadiene-based poly(urea-urethane) (PBPUU), polypropylene glycol-based poly(urea-urethane) (PPGPUU), polyester-based poly(urea-urethane), and polyimide-based poly(urea-urethane), wherein said polymeric chains are dynamically crosslinked via disulfide crosslinking bridges.

45. The composite material according to claim 40, wherein the first layer, the second layer, or both further comprise at least two electrodes electrically connected to the network of the first nanomaterial and/or the network of the second nanomaterial, respectively, and to the mutual control circuit.

46. The composite material according to claim 45, wherein the network of the first nanomaterial is arranged as a continuous pathway between the at least two electrodes; or wherein the network of the first nanomaterial is arranged as a single continuous electrical pathway.

47. The composite material according to claim 46, wherein the first nanomaterial covers at least about 5% of a total area occupied by said network; or wherein the network of the second nanomaterial has a random network configuration of the second nanomaterial disposed between the at least two electrodes, wherein said network covers at least about 20% of the surface confined by the at least two electrodes.

48. The composite material according to claim 40, wherein the first layer comprises a plurality of networks of the first nanomaterial and the second layer comprises a plurality of networks of the second nanomaterial, wherein each network of the plurality of networks of the first nanomaterial is associated with a respective network of the plurality of networks of the second nanomaterial, such that the mutual control circuit is configured to apply voltage to any network of the plurality of networks of the second nanomaterial upon a change in the resistance of the respective network of the plurality of networks of the first nanomaterial.

49. The composite material according to claim 48, wherein positions of the plurality of networks of the first nanomaterial along the first layer are aligned with the positions of the plurality of networks of the second nanomaterial along the second layer.

50. A sensing platform unit comprising:
a self-healing polymer matrix and at least three conductive nanomaterials embedded therein,
wherein the polymer matrix has a multi-layer structure comprising:
a first layer comprising a network of a first nanomaterial, which resistance changes in response to a mechanical damage inflicted on the polymer matrix;
a second layer comprising a network of a second nanomaterial, configured to generate heat under applied voltage; and
a third layer comprising a network of a third nanomaterial configured to detect at least one of pressure, strain, temperature, pH, humidity, and volatile organic compounds (VOCs);
wherein the network of the first nanomaterial and the network of the second nanomaterial are electrically connected to a mutual control circuit which is configured to apply voltage to the second nanomaterial upon a change in resistance of the first nanomaterial.

51. The sensing platform unit according to claim 50, wherein the first layer is disposed between the second layer and the third layer, or wherein the first layer is disposed between the second layer and the third layer and the network of the first nanomaterial and the network of the second nanomaterial are disposed at the same vertical location of the composite material.

52. The sensing platform unit according to claim 50, wherein the first nanomaterial is selected from the group consisting of a carbonaceous material, a metal, a conductive polymer, and combinations thereof; or wherein the first nanomaterial is a carbonaceous material selected from the group consisting of carbon black nanoparticles, carbon nanotubes (CNTs), graphene, and combinations thereof; or wherein the first nanomaterial comprises carbon black nanoparticles.

53. The sensing platform unit according to claim 50, wherein the network of the second nanomaterial is a percolation network; or wherein the second nanomaterial comprises metallic nanowires; or wherein the second nanomaterial comprises metallic nanowires selected from the group consisting of silver nanowires (AgNWs), gold nanowires (AuNWs), copper nanowires (CuNWs), and combinations thereof.

54. The sensing platform unit according to claim 50, wherein the third nanomaterial is selected from the group consisting of silver nanowires (AgNWs), metallic nanoparticles capped with an organic coating, single walled carbon nanotubes (SWCNTs), carbon particles, graphene, and combinations thereof, or wherein the self-healing polymer comprises polymeric chains selected from the group consisting of polybutadiene-based poly(urea-urethane) (PBPUU), polypropylene glycol-based poly(urea-urethane) (PPGPUU), polyester-based poly(urea-urethane), and polyimide-based poly(urea-urethane), wherein said polymeric chains are dynamically crosslinked via disulfide crosslinking bridges.

55. The sensing platform unit according to claim 50, wherein the first layer, the second layer, or both further comprise at least two electrodes electrically connected to the network of the first nanomaterial and/or the network of the second nanomaterial, respectively, and to the mutual control circuit.

56. The sensing platform unit according to claim 55, wherein the network of the first nanomaterial is arranged as a continuous pathway between the at least two electrodes; or wherein the network of the first nanomaterial is arranged as a single continuous electrical pathway.

57. The sensing platform unit according to claim 56, wherein the first nanomaterial covers at least about 5% of a total area occupied by the network; or wherein the network of the second nanomaterial has a random network configuration of the second nanomaterial disposed between the at least two electrodes, wherein said network covers at least about 20% of the surface confined by the at least two electrodes.

58. The sensing platform unit according to claim 50, wherein the third layer further comprises at least two electrodes electrically connected to the network of the third nanomaterial; or wherein the first layer comprises a plurality of networks of the first nanomaterial, the second layer comprises a plurality of networks of the second nanomaterial, and the third layer comprises a plurality of networks of the third nanomaterial, wherein each network of the plurality of networks of the first nanomaterial is associated with a respective network of the plurality of networks of the second nanomaterial, such that the mutual control circuit is configured to apply voltage to any network of the plurality of networks of the second nanomaterial upon a change in the resistance of the respective network of the plurality of networks of the first nanomaterial; or wherein the third layer comprising at least one of a temperature sensor comprising AgNWs, pressure sensor comprising AgNWs and carbon black-PPGPUU composite, and a pH sensor comprising AgNWs and semi-conductive SWCNTs.

59. The sensing platform unit according to claim 58, wherein positions of the plurality of networks of the first nanomaterial along the first layer is aligned with the positions of the plurality of networks of the second nanomaterial along the second laver.
